(19) United States
(12) Patent Application Publication
(10) Pub. No.: US 2011/0003035 A1
(43) Pub. Date: Jan. 6, 2011

(54) YEAST COMPOSITION AND ITS USE AS COW FEED ADDITIVE

(76) Inventors: Xuefeng YU, Yichang (CN); Zhihong LI, Yichang (CN); Minghua YU, Yichang (CN); Juan YAO, Yichang (CN); Ling LI, Yichang (CN); Bin TAN, Yichang (CN)

Correspondence Address: MATTHIAS SCHOLL, 14781 MEMORIAL DRIVE, SUITE 1319, HOUSTON, TX, 77079, US

(21) Appl. No.: 12/880,175

(22) Filed: Sep. 13, 2010

Related U.S. Application Data
(63) Continuation of application No. PCT/CN2008/072978, filed on Nov. 7, 2008.

(30) Foreign Application Priority Data
Mar. 18, 2008 (CN) 200810084032.9

(51) Int. Cl. A23K 1/18; A23K 1/16

(52) U.S. Cl. 426/62

(57) ABSTRACT

Yeast composition for cow feed additive including at least ruminant yeast and a carrier. The carrier is selected from DDGS (corn lees), chaff, zein powder, brewery mash, bean pulp, soybeanhull, rice bran, or wheat bran. The yeast composition can alleviate the negative effects of heat stress experienced by cows during summer months and improve milk yield.

### CROSS-REFERENCE TO RELATED APPLICATIONS

This application is a continuation of International Patent Application No. PCT/CN2008/072978 with an international filing date of Nov. 7, 2008, designating the United States, now pending, and further claims priority benefits to Chinese Patent Application No. 200810084032.9 filed Mar. 18, 2008. The contents of all of the aforementioned applications, including any intervening amendments thereto, are incorporated herein by reference.

### BACKGROUND OF THE INVENTION

1. Field of the Invention

The invention relates to a feed additive for ruminants, and more particularly to feed additive comprising yeast for ruminants.

2. Description of the Related Art

Fungal culture extracts have been regarded as the most potential feed additive to increase cellulose degradability in rumen. Yeast culture (YC), an important microbial ecological product of fungal culture, is obtained by processing a mixture of fermentation products and the culture medium thereof. The fermentation is carried out strictly in a liquid and then a solid medium or directly in a solid medium. Yeast culture has a variety of digestive enzymes and nutritional metabolites produced by fermentation, and can be stored stably for a long time even in hot and wet environments. Thus, it improves the palatability and digestibility of diet.

More and more ruminant feeds include yeast culture. Research institutions and companies are trying to produce ruminant feeds by substituting the yeast culture with live yeast. However, the results are negative. For example, the relative metabolic activity of yeast culture and commercial live yeast has been studied in vitro. As far as the production of volatile fatty acids (VFA) is concerned, the experimental group of live yeast is higher than the grain control group, but obviously lower than the yeast culture (as shown in Table 1).

TABLE 1
Production of VFA in the presence of rumen microorganisms after
adding yeast culture or live yeast

| | Yeast | Grain | Live |
|---|---|---|---|
| VFA (mM) | culture | control group | yeast |
| Acetic acid | 27.74^{a} | 24.36^{b} | 25.71^{c} |
| Propionic acid | 26.77^{a} | 22.94^{b} | 22.90^{b} |
| Total amount | 60.42^{a} | 52.06^{b} | 53.97^{c} |

Note:
^{a-c}P < 0.05

As shown in Table 1, the live yeast basically has no influence on the production of VFA in the presence of rumen microorganisms.

Thus, conventional concepts consider that, the function of yeast products originates from the fermentation metabolites but not the yeast itself. Temperature and chemical composition of rumen fluid seems to be an inhibitor of yeast propagation, and within a few hours after entering the rumen, the yeasts disappear.

### SUMMARY OF THE INVENTION

In view of the above-described problems, it is one objective of the invention to provide a cow feed additive comprising a live dry yeast.

To achieve the above objective, in accordance with one embodiment of the invention, there is provided a yeast composition for cow feed additive comprising ruminant yeast and a carrier. The ruminant yeast has been produced and sold by the applicant, for example, a specific yeast product for ruminants with a brand name of “high active dry feed yeast”, in which the effective active yeast is about 20 billion cfu/g. The carrier is selected from the group consisting of DDGS (corn lees), chaff, corn gluten meal, brewery mash, soybean meal, soybean hull, rice bran, wheat bran, and so on, among which DDGS is preferable.

The yeast composition further comprises a bacillus subtilis, and the effective active bacillus subtilis is about 20 billion cfu/g. The weight ratio of the ruminant yeast to the bacillus subtilis is between 10:3 and 10:7.

The yeast composition further comprises a yeast selenium, and the content of the yeast selenium is 1,000 mg/Kg or so. The weight ratio of the ruminant yeast to the yeast selenium is between 10:5 and 10:9.

The yeast composition further comprises a Vitamin A powder (500,000 IU, purchased from market). The weight of the Vitamin A powder doesn't exceed 10% of the ruminant yeast.

The yeast composition further comprises a Vitamin E powder (purchased from market) comprising 50% of Vitamin E. The weight of the Vitamin E powder doesn't exceed 30% of the ruminant yeast.

Different from prior art, the yeast composition of the invention can be directly used as a cow feed additive and exhibits positive effect, for example, improve the milk yield. Due to the introduction of the carrier, the live yeast is more convenient for mixing, and the resultant product is more uniform and stable in properties.

### DETAILED DESCRIPTION OF THE EMBODIMENTS

A ruminant yeast (Saccharomyces cerevisiae) specific for cow feed is deposited under China Center for Type Culture Collection No. M207177. The yeast is cultured with pretreated and fermentable sugar cane molasses as a liquid medium. After several times of amplification culture, the yeast is enriched, then centrifugated, washed, and dried to yield a high active dry product.

The ruminant yeast is produced by the following process: slant culture-F bottle culture-Puntbus tank culture-pure culture-commercial fermentation culture-centrifugation and washing-filtering-granulating-drying-vacuum packaging. Sucrose solid medium is used for the slant culture which lasts for 48 hrs at 30° C. The solid medium comprises 4% of sucrose, 2% of yeast extract, 0.1% of MgSO₄, 0.1% of KH₂PO₄, and 2% of agar powder, with a pH value of 6.5. Sucrose liquid medium is used for the F bottle and Puntbus culture which last for 24 hrs at 30° C. The liquid medium comprises 4% of sucrose, 2% of yeast extract, 0.1% of MgSO₄, and 0.1% of KH₂PO₄, with a pH value of 6.5. The pure culture comprises feeding once and fermentation in batches. The fermentation formula comprises 6.4 m³ of process water, 1950 L of 30% molasses, 12 kg of ammonium dihydrogen phosphate, 20 kg of urea, 2 kg of zinc sulfate, 5 kg of magnesium sulfate, 25 kg of yeast extract, and 100 g of biotin, with a pH value of 4.1-4.3. The fermentation is carried out at 29-30° C. for 24 hrs with a wind flow of 100 m³/h. The commercial fermentation culture is carried out in a continuous fed-batch mode following conventional conditions. The fermentation formula comprises 60 m³ of process water, 31,300 L of 30% molasses, 1,080 L of 10% potassium dihydrogen phosphate, 1,820 L of 15% urea, 100 kg of zinc sulfate, 100 kg of magnesium sulfate, 100 g of biotin, and 360 g of thiamine. The fermentation solution is centrifugated thrice at 4,000 rpm, washed, and filtered to yield a yeast slurry comprising 25% of dry matters. The yeast slurry is granulated and dried at 90° C. for 30-60 min to yield a semifinished product comprising 95% of dry matters. The semifinished product is examined and packed to be a qualified ruminant yeast.

The carrier used in this invention is compatible with the yeast and causes no harm to mammalians. They may be, for example, conventional pharmaceutical carriers, and generally, solid carriers. The solid carriers include but are not limited to DDGS (corn lees), chaff, corn gluten meal, brewery mash, soybean meal, soybean hull, rice bran, and wheat bran, among which DDGS is preferable. The usage amount of the carriers has no strict limit. For example, it can exceed 0.5 time (by weight) the usage amount of the yeast, particularly exceed one time, so as to increase the volume of the composition and produce a uniform mixture. If another active ingredient, such as bacillus subtilis, yeast selenium, vitamin, or a mixture thereof, is used, the weight ratio thereof (including the cow yeast) to that of the carriers is generally between 1:1 and 1:15. Generally, the usage amount of the carriers is determined by the daily feeding amount of the active ingredients (particularly the cow yeast), the binding capacity of the carriers with the active ingredients, and the taste and the cost of the carriers. Once the daily feeding amount of the active ingredients is determined, the carrier amount can be determined accordingly so that the yeast composition can be mixed with feeds conveniently and uniformly. For carriers with good taste and easily to be absorbed, the usage amount may be large; for those with bad tasted and not easily to be absorbed, the usage amount may be small. Furthermore, the cost and whether to be mixed easily are factors to select the carriers. In one embodiment, the weight ratio of the active ingredients to the carriers is between 1:2 and 1:10. In another embodiment, with DDGS as the carriers, the weight ratio of the active ingredients to the carriers is between 1:2.5 and 1:3.5, and the mixing effect is good and the composition is easy for application.

In the invention, the carriers prevent unstable effect of the yeast composition resulting from the heterogenous mixing between a small amount of cow yeast and feeds. The yeast composition comprising the carriers is very convenient and reliable for feeding.

The yeast composition further comprises a bacillus subtilis. The addition of the cow yeast can only benefit the rumen fermentation, but the milk yield and cow health are not so stable. The addition of bacillus subtilis improves the effect and stability of the composition. Preferably, the weight ratio of the Angel ruminant yeast to the bacillus subtilis is between 10:3 and 10:7. The bacillus subtilis can be purchased, for example, Fubon bacillus subtilis, from Angle Yeast Co., Ltd.

The yeast composition further comprises a yeast selenium. The product comprises the yeast selenium is very suitable for cows in areas short of selenium. The yeast selenium has good compatibility with the yeast used in the invention. Most of Chinese territory lacks of selenium seriously, particularly in cow breeding areas. The addition of selenium-enriched yeast effectively solves the problem of low milk yield resulted from natural selenium shortage. For Northeast China, North China, and Northwest China where selenium is seriously lacked, when the addition amount of the yeast is 1-2 g/cow·day, the weight ratio of the Angel ruminant yeast to the yeast selenium is between 10:5 and 10:9. Currently, yeast selenium can be purchased all over the world, for example, Fubon yeast selenium produced by Angle Yeast Co., Ltd., and Sel-Plex produced by Alltech Biotechnology Inc.

In addition, the yeast composition further comprises appropriate Vitamin A powder and/or Vitamin E powder, both of which are purchased from market. The addition amount of the Vitamin A powder doesn't exceed 10 wt. % of the ruminant yeast. The addition amount of the Vitamin E powder doesn't exceed 30 wt. % of the ruminant yeast.

Conventional mixing methods for producing the composition are practicable in the invention. That is to say, it is feasible to mix the components in a reactor with a stirrer at appropriate temperature (generally room temperature).

### Example 1

### Production of Product

10 weight parts of ruminant yeast and 90 weight parts of DDGS are stirred and mixed using a high efficiency mixer to yield product 1.

### Example 2

### Production of Product

10 weight parts of ruminant yeast, 3 weight parts of a bacillus subtilis (Fubon bacillus subtilis produced by Angle Yeast Co., Ltd.), and 85 weight parts of DDGS are stirred and mixed using a high efficiency mixer to yield product 2.

### Example 3

### Production of Product

10 weight parts of ruminant yeast, 7 weight parts of a bacillus subtilis (Fubon bacillus subtilis produced by Angle Yeast Co., Ltd.), 5 weight parts of yeast selenium (Fubon yeast selenium, produced by Angle Yeast Co., Ltd.), and 78 weight parts of corn gluten meal are stirred and mixed using a high efficiency mixer to yield product 3.

### Example 4

### Production of Product

10 weight parts of ruminant yeast, 5 weight parts of a bacillus subtilis (Fubon bacillus subtilis produced by Angle Yeast Co., Ltd.), 9 weight parts of yeast selenium (Fubon yeast selenium, produced by Angle Yeast Co., Ltd.), 75.1 weight parts of soybean hulls, 0.4 weight parts of Vitamin A, and 2 weight parts of Vitamin E are stirred and mixed using a high efficiency mixer to yield product 4.

### Example 5

### Influence of Yeast Composition on Milk Yield

Cows with similar age, birth order, good physical conditions, and disease-free are selected. The cows are divided into 5 groups with each of 16. In each group, the average of birth order, days in milk, and milk yield are basically identical. The diet is prepared according to the existing feeds and the production capacity thereof. Based on the diet, to each cow of the first group, every noon 20 g of the product 1 are fed, to the second group 20 g of the product 2 are fed, to the third group 20 g of the product 3 are fed, to the fourth group 20 g of the product 4 are fed. The fifth group is the control group, in which 2 g of pure Angel ruminant yeast are fed to each cow. The cows are fed continuously from Oct. 10, 2007 to Nov. 15, 2007. The details of the cows in the groups are listed in Table 2.

TABLE 2
Physical parameters of cows

| | Birth | Days in | Milk yield on |
|---|---|---|---|
| | order | milk | Oct. 10 (Kg/day) |
| First group | 1.8 | 145 | 18.6 |
| Second group | 2 | 148 | 19 |
| Third group | 1.9 | 155 | 19.2 |
| Fourth group | 2.1 | 150 | 18.8 |
| Control group | 2 | 153 | 19.1 |

The days in milk are calculated from the day the calf was born to the day just before starting the experiments. Pre-experiments refer to prior to the experiments, and the milk yield is obtained just before the day starting the experiments. Adaption period refers to days in which the yeast composition is used for adaptive feeding. In the adaption period, the milk yield fluctuates and thereby the data is not reliable. Experiment period follows the adaption period, in which the milk yield doesn't fluctuate and the data is reliable. The results are listed in Table 3.

TABLE 3
Average milk yield of cows in different periods

| | Pre- | Adaption | Adaption | Experiment | Experiment | Experiment | Average of | |
|---|---|---|---|---|---|---|---|---|
| | experiment | period | period | period | period | period | experiment | |
| | 10.10 | 10.17 | 10.24 | 11.1 | 11.8 | 11.15 | period | Effect |
| Control | 19.1 | 19.1 | 18.7 | 18.4 | 18.5 | 18 | 18.3 | −0.8 |
| group | | | | | | | | |
| First | 18.6 | 18.6 | 18.7 | 18.7 | 18.5 | 18.8 | 18.67 | +0.07 |
| group | | | | | | | | |
| Second | 19 | 19.1 | 18.8 | 19.2 | 19.4 | 19.2 | 19.27 | +0.27 |
| group | | | | | | | | |
| Third | 19.2 | 19 | 18.8 | 19.4 | 19.3 | 19.6 | 19.44 | +0.24 |
| group | | | | | | | | |
| Fourth | 18.8 | 18.8 | 19 | 19.3 | 19.2 | 19.3 | 19.3 | +0.5 |
| group | | | | | | | | |

In the whole experiment periods, weather is good for cow to produce milk. Thus, the experiment is hardly affected by external factors. As shown in Table 3, during the experiment period, there is a huge disparity in the milk yield between the experimental groups and the control group. The milk yield of the experimental groups is much more than that of the control group. Thus, the yeast composition has remarkable effect in stabilizing and improving milk yield. The milk yield of the control group decreases by 0.8 Kg/day per cow, but that of the experimental groups is stable and enhanced. Table 3 also shows the trend of milk yield in different periods. In the first half month, the milk yield of all the groups is stable. After entering the experiment period, the milk yield of all experiment groups is more than that of the control group, and the increase rate is 0.87 kg/day per cow, 1.07 kg/day per cow, 1.02 kg/day per cow, and 1.3 kg/day per cow, respectively. Obviously, the fourth group is the best in improving milk yield because it contains many functional active ingredients. The first group has a slight effect. The second and third groups are good and equal in improving milk yield.

During the experiments the inventor unexpectedly discovers that, different from what is taught by the prior art, the composition comprising live yeast can be used for cow feed and exhibits good activity.

The above experiments show that, for cows in the middle and late milking period, to feed the yeast composition can effectively stabilize the milk yield, and even improve the milk yield by 0.5-1.5 kg/day per cow. The yeast composition increases milk yield by improving microbial environment in rumen. Thus, the invention overcomes the prejudices of the prior art by directly adding live yeast as an additive to cow feed and obtaining a positive effect.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A yeast composition for a cow feed additive, the composition comprising:
ruminant yeast and a carrier, wherein the effective active ruminant yeast is 20 billion cfu/g or so.

2. The yeast composition of claim 1, further comprising a bacillus subtilis, wherein the effective active bacillus subtilis is 20 billion cfu/g or so, and a weight ratio of said ruminant yeast to said bacillus subtilis is between 10:3 and 10:7.

3. The yeast composition of claim 2, further comprising yeast selenium, wherein the content of the yeast selenium is 1,000 mg/kg or so, and a weight ratio of said ruminant yeast to said yeast selenium is between 10:5 and 10:9.

4. The yeast composition of claim 3, further comprising a Vitamin A powder with 500,000 IU, wherein a weight of the Vitamin A powder doesn't exceed 10% of said ruminant yeast.

5. The yeast composition of claim 4, further comprising a Vitamin E powder with 50% of Vitamin E, wherein a weight of the Vitamin E powder doesn't exceed 30% of said ruminant yeast.

6. The yeast composition of claim 5, comprising 10 weight parts of said ruminant yeast, 5 weight parts of said bacillus subtilis, 7.5 weight parts of said yeast selenium, 75.1 weight parts of said carrier, 0.4 weight parts of said Vitamin A powder, and 2 weight parts of said Vitamin E powder.

7. The yeast composition of claim 6, wherein said carrier is selected from the group consisting of corn lees, chaff, corn gluten meal, brewery mash, soybean meal, soybean hull, rice bran, and wheat bran.

8. The yeast composition of claim 7, wherein said carrier is corn lees.

9. The yeast composition of claim 1, wherein said carrier is selected from the group consisting of corn lees, chaff, corn gluten meal, brewery mash, soybean meal, soybean hull, rice bran, and wheat bran.

10. The yeast composition of claim 9, wherein said carrier is corn lees.

11. The yeast composition of claim 1, wherein said ruminant yeast is produced, with Saccharomyces cerevisiae as a seed, by process of slant culture, F bottle culture, Puntbus tank culture, pure culture, commercial fermentation culture, centrifugation and washing, filtering, granulating, and drying.

12. The yeast composition of claim 11, wherein a sucrose solid medium used for said slant culture comprises 4% of sucrose, 2% of yeast extract, 0.1% of MgSO₄, 0.1% of KH₂PO₄, and 2% of agar powder, with a pH value of 6.5.

13. The yeast composition of claim 11, wherein a sucrose liquid medium used for said F bottle and Puntbus culture comprises 4% of sucrose, 2% of yeast extract, 0.1% of MgSO₄, and 0.1% of KH₂PO₄, with a pH value of 6.5.

14. The yeast composition of claim 11, wherein a fermentation formula used for said pure culture comprises 6.4 m³ of process water, 1950 L of 30% molasses, 12 kg of ammonium dihydrogen phosphate, 20 kg of urea, 2 kg of zinc sulfate, 5 kg of magnesium sulfate, 25 kg of yeast extract, and 100 g of biotin, with a pH value of 4.1-4.3.

15. The yeast composition of claim 11, wherein a fermentation formula used for said commercial fermentation culture comprises 60 m³ of process water, 31,300 L of 30% molasses, 1,080 L of 10% potassium dihydrogen phosphate, 1,820 L of 15% urea, 100 kg of zinc sulfate, 100 kg of magnesium sulfate, 100 g of biotin, and 360 g of thiamine.

16. A cow feed additive comprising ruminant yeast and a carrier, wherein said cow feed additive is formulated as food for cows.
